(19) United States
(12) Patent Application Publication
(10) Pub. No.: US 2014/0129249 A1
(43) Pub. Date: May 8, 2014

(54) SYSTEM AND METHOD FOR MONITORING AND FEEDBACK OF CHRONIC MEDICAL CONDITIONS

(71) Applicant: University of Utah Research Foundation, Salt Lake City, UT (US)

(72) Inventors: Flory Nkoy, Salt Lake City, UT (US); Bernard Fassl, Salt Lake City, UT (US); Bryan Stone, Salt Lake City, UT (US); Christopher Maloney, Salt Lake City, UT (US)

(21) Appl. No.: 14/073,457

(22) Filed: Nov. 6, 2013

Related U.S. Application Data
(60) Provisional application No. 61/723,090, filed on Nov. 6, 2012.

(51) Int. Cl. G06F 19/00

(52) U.S. Cl. CPC G06F 19/34
USPC 705/2

(57) ABSTRACT

A system and method for improving asthma management is disclosed. A server receives periodic asthma control test (ACT) results from a patient. The server is in communication with a care coordinator such as a health care clinic. The server identifies an ACT score for each ACT. The server sends at least one of the ACT results and the ACT score to the care coordinator to enable the care coordinator to monitor the asthma management of the patient.

### RELATED APPLICATION(S)

This application claims the benefit of U.S. Provisional Application No. 61/723,090, filed Nov. 6, 2012, which is incorporated herein by reference.

### GOVERNMENT INTEREST

This invention was made with government support under Grant No. 1R18HS018166-01A1 awarded by the Agency for Healthcare Research and Quality. The federal government has certain rights in the invention.

### BACKGROUND

Chronic medical conditions represent an expensive and time consuming burden for both patients and health care providers. Proper management of chronic medical conditions often requires regular, frequent longitudinal monitoring and treatment adjustment, a feat difficult to achieve in the current U.S. health care system practices and available options but with the potential to reduce the costs of health care and improve the health of patients.

Asthma is one example of a chronic medical condition that can be difficult to manage as a health care provider. The severity of asthma in an asthma patient can be difficult to determine because less severe symptoms can be easily ignored by the patient, until the patient has an asthma attack or flare-up. Up to forty percent of children hospitalized for asthma are readmitted to the hospital for asthma within one year of the prior hospitalization. Many such chronic medical conditions can be effectively managed such that patients can avoid costly, dangerous and inconvenient more aggressive medical interventions. Unfortunately, a lack of information regarding the current and ongoing status of the patient can make it difficult for health care providers to manage the medical condition of the patient. A lack of timely information can also result in patients using higher cost health care options, such as emergency rooms, walk-in clinics and observational areas more often than primary care providers (PCP). This can place an undue burden both on the patients and the health care system in terms of costs, lack of continuity of care, substandard care and inappropriate use of resources.

### SUMMARY

In one aspect, a method for improving asthma management of a patient can include receiving, at a server, periodic asthma control test (ACT) results from the patient. The server can be in communication with a care coordinator, such as a health care clinic. The method can also include identifying, at the server, an ACT score for the patient in each asthma control test. At least one of the ACT results and the ACT score for each ACT can be sent from the server to the care coordinator to enable the care coordinator to monitor the asthma management of the patient.

In another aspect, a chronic medical condition management system can include a chronic medical condition management (CMCM) module residing on a server. The CMCM module can be configured to receive, at a periodic rate, chronic medical condition management test (CMCMT) results from a patient computing device. A CMCMT score module in communication with the server can be configured to identify a CMCMT score from the CMCMT. A communication module can also be in communication with the CMCM module. The communication module can be configured to electronically communicate at least one of the CMCMT results and the CMCMT score to a care coordinators computing device to enable the care coordinator to monitor a chronic medical condition of a patient over a selected period of time based on data received at the periodic rate.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

Features and advantages of the invention will be apparent from the detailed description which follows, taken in conjunction with the accompanying drawings, wherein:

FIG. 1 is a flow chart of a method for improving asthma management of a patient in accordance with an embodiment of the present invention;

FIG. 2 is a flow chart of a system for improving asthma management in accordance with an embodiment of the present invention;

FIG. 3 illustrates a graph of test results of a patient displayed by a system for improving asthma management in accordance with an embodiment of the present invention; and

FIG. 4 illustrates an example of a chronic medical condition management system in accordance with an embodiment of the present invention.

These drawings are provided to illustrate various aspects of the invention and are not intended to be limiting of the scope in terms of dimensions, materials, configurations, arrangements or proportions unless otherwise limited by the claims. Reference will now be made to the exemplary embodiments illustrated, and specific language will be used herein to describe the same. It will nevertheless be understood that no limitation of the scope of the invention is thereby intended.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### DEFINITIONS

In describing and claiming the present invention, the following terminology will be used in accordance with the definitions set forth below.

As used herein, “health care provider” refers to an entity that provides health care services to patients. Health care providers can broadly include individuals such as primary care providers, nurse managers, clinic managers, etc., and organizations such as clinics, doctor's offices, hospitals, etc.

In this disclosure, “comprises,” “comprising,” “containing” and “having” and the like can have the meaning ascribed to them in U.S. Patent law and can mean “includes,” “including,” and the like, and are generally interpreted to be open ended terms. The term “consisting of” is a closed term, and includes only the devices, methods, compositions, components, structures, steps, or the like specifically listed, and that which is in accordance with U.S. Patent law. “Consisting essentially of” or “consists essentially” or the like, when applied to devices, methods, compositions, components, structures, steps, or the like encompassed by the present disclosure, refers to elements like those disclosed herein, but which may contain additional structural groups, composition components, method steps, etc. Such additional devices, methods, compositions, components, structures, steps, or the like, etc., however, do not materially affect the basic and novel characteristic(s) of the devices, compositions, methods, etc., compared to those of the corresponding devices, compositions, methods, etc., disclosed herein. In further detail, “consisting essentially of” or “consists essentially” or the like, when applied to devices, methods, compositions, components, structures, steps, or the like encompassed by the present disclosure have the meaning ascribed in U.S. Patent law and the term is open-ended, allowing for the presence of more than that which is recited so long as basic or novel characteristics of that which is recited is not changed by the presence of more than that which is recited, but excludes prior art embodiments. When using an open ended term, like “comprising” or “including,” it is understood that direct support should be afforded also to “consisting essentially of” language as well as “consisting of” language as if stated explicitly.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range includes “about ‘x’ to about ‘y’”. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

As will be apparent to those of skill in the art upon reading this disclosure, each of the individual embodiments described and illustrated herein has discrete components and features that may be readily separated from or combined with the features of any of the other several embodiments without departing from the scope or spirit of the present disclosure. Any recited method can be carried out in the order of events recited or in any other order that is logically possible.

It is noted in the present disclosure that when describing the systems or methods, individual or separate descriptions are considered applicable to one another, whether or not explicitly discussed in the context of a particular example or embodiment. For example, in discussing a particular system per se, the method embodiments are also inherently included in such discussions, and vice versa.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

Monitoring and Feedback of Chronic Medical Conditions

The ability to record, track, and monitor health information of patients having a chronic medical condition can significantly improve the management of the medical condition. In addition, the ability of a health care provider to track and monitor the health information of patients having chronic medical conditions allows the health care provider to make more timely decisions and more informed decisions to manage the medical condition. A proactive, preventative approach to the management of chronic medical conditions by early interventions such as medication adjustments and additional strategies such as trigger identification and avoidance in asthma will improve care in the management of chronic illness. The improved management of the chronic medical condition by both the patient and the health care provider can significantly reduce or in many cases eliminate the number of times a patient needs a rapid, emergency response, such as a trip to the emergency room. Instead, a relatively low cost health care provider, such as a health care clinic, can coordinate care between a patient and a primary care provider (PCP) of the patient. In addition, the overall health and well-being of the patient can be improved through better management of the chronic medical condition.

The inventors have developed an effective method for managing chronic medical conditions of patients. The method involves receiving results of regularly scheduled periodic tests taken by the patient, which indicate the level of control of the medical condition. A score can be given based on the test results and the scores and/or test results of the patient can be monitored by a care coordinator and a primary care provider. This can provide longitudinal data about the medical condition, which can help the care coordinator and primary care provider manage the medical condition of the patient. If needed, changes can be made to the management plan for the medical condition to help the patient avoid using emergency treatment such as the emergency room. Throughout this disclosure, references will be made to embodiments involving asthma control. However, it is to be understood that the invention can be applied to many other chronic medical conditions as well, and should not be limited to asthma control only. Other conditions amenable to this monitoring and intervention model can include, but are not limited to, adult asthma, chronic obstructive pulmonary disease, diabetes mellitus in children and adults, congestive heart failure, arthritis, hypertension, obesity, psychiatric conditions, pregnancy, migraine headache, allergies, addiction medicine, inflammatory bowel diseases, and technology dependencies. The characteristics of illnesses susceptible to this model of care are, in general, an illness sensitive to self-monitoring over time, self-monitoring can be tied to a specific change in treatment, there can be bi-directional communication of self-monitoring outcome between the patient and the care coordinator or other clinician who can effect a change in response to the self-monitoring. Additional related characteristics include optional integration of external pertinent data (such as pollen counts in asthma) and the option to interact directly with an independent monitoring device to obtain data (such as a glucometer in diabetes mellitus).

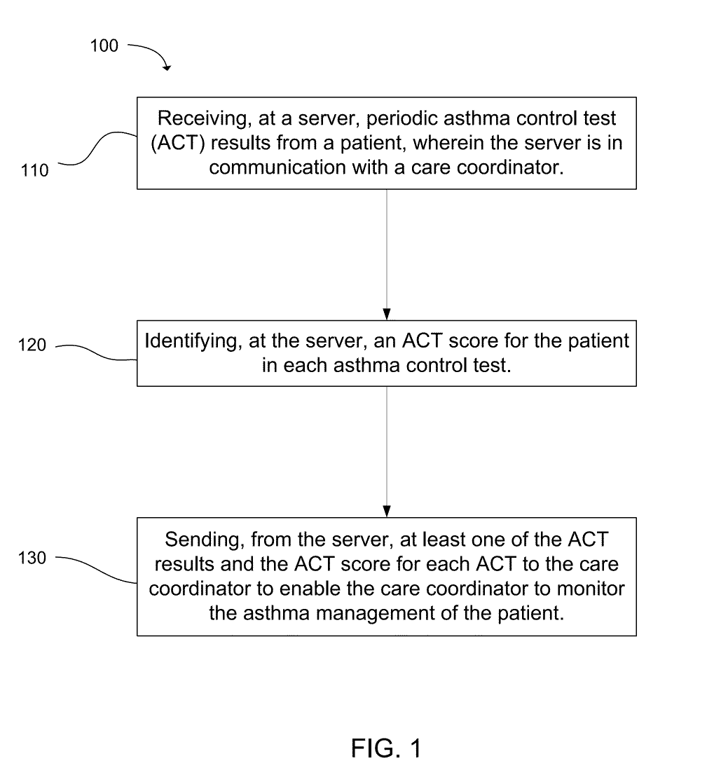

A flowchart of an exemplary method in accordance with an embodiment of the present invention is shown in FIG. 1. A method 100 for improving asthma management in a patient can include receiving 110, at a server, periodic asthma control test (ACT) results from the patient, wherein the server is in communication with a care coordinator; identifying 120, at the server, an ACT score for the patient in each asthma control test; and sending 130, from the server, at least one of the ACT results and the ACT score for each ACT to the care coordinator to enable the care coordinator to monitor the asthma management of the patient.

The server can receive results of a periodic asthma control test (ACT) from the patient at a specified periodic rate. The test can include questions about asthma symptoms to be answered by the patient. The questions can be multiple-choice questions with several answers from which the patient can select. The questions and answers can be adapted so that when a patient completes the test at the periodic rate, the test will produce a score that is relevant to determining the level of control of asthma of the patient.

A standard ACT has been used previously in clinical settings. The questions of the standard ACT are designed so that lower scores on the ACT correspond to poorer levels of control over asthma. Therefore, lower scores are used to alert a health care provider that the therapy for the patient may need to be adjusted. However, the standard ACT covers information about asthma control over the previous four weeks and is usually applied intermittently when a patient visits an emergency room or hospital for acute care. Standard questions which contribute to calculation of scores include factors such as frequency of symptoms (optionally separate frequencies of each targeted symptom), interruption of usual daily activities by the disease, use of acute reliever medications, specific measures of disease activity or control, measures of current medication effectiveness and side effects, and overall sense of current disease status.

A periodic ACT can be administered according to a regular schedule, so that the asthma control level of the patient can be monitored over time. This can allow a health care provider to find trends in the asthma control of the patient and to identify a need for intervention in the asthma therapy of the patient before an acute flare-up occurs. By monitoring the trajectory of the asthma control level of the patient, the health care provider can more easily predict whether the asthma control level is likely to drop in the future. Therefore, the methods of the present invention are preventative methods used to avoid acute asthma symptoms rather than reactive methods used to adjust therapies after acute flare-ups.

In some embodiments, the periodic ACT results can be received more frequently than the standard ACT period of four weeks, and typically at least more frequently than once every three weeks. For example, the periodic rate at which the periodic ACT results are received can in some cases be from 3-21 days, in some cases from 4-12 days, in some cases from 5-9 days, and in one example the period can be one week. Of course, in embodiments intended to monitor other chronic medical conditions besides asthma, other periodic rates can be appropriate. The periodic frequency can generally be based on the type of chronic health condition and the type of information desired to be collected from the patient.

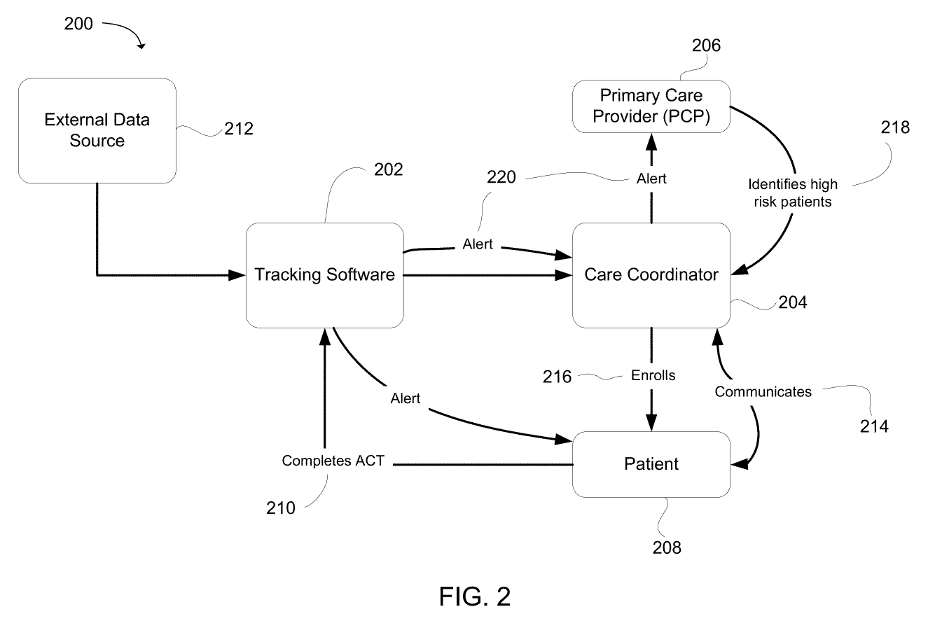

As shown in FIG. 1, the periodic ACT results can be received 110 at a server. In some embodiments, the periodic ACT can be implemented as a tracking software program run on the server for tracking the asthma control of the patient. FIG. 2 is a flowchart showing a system 200 for improving asthma management, including tracking software 202, and the interactions between the software and a care coordinator 204, a primary care provider (PCP) 206, and a patient 208. The patient completes ACT questionnaires 210 and sends the results, which are received by the tracking software on the server. Typically the patient can complete the ACTs through a web or smartphone app-enabled computing device such as a personal computer, smartphone, or tablet computer although other input devices can be suitable. In one embodiment, the tracking software can present the ACT in the form of a website which can be displayed in a web browser on the patient computing device. The ACT can include questions for which the patient inputs answers that are received by the server.

The tracking software can be configured and designed for specific chronic health conditions. For instance, the tracking software can include specific questions regarding the health of the patient and/or management of one or more chronic health conditions. The particular questions and answers for a disease-specific tracking software program can be validated scientifically as capable of providing valid and important information about the chronic illness, stage of development, and can include information to determine patience compliance with a current disease management program. In one embodiment, one or more of the questions can have a score, such as a numerical value, associated with the answer given by the patient.

In one specific embodiment, the tracking software can be an electronic application environment which tracks and collects such data. Results can allow patients and caregivers to improve self-monitoring and self-management in order to prompt early response to deteriorations in chronic asthma control status and to support PCPs with longitudinal data to assess the effectiveness of asthma therapy and prompt adjustments. The application environment allows patients to complete a weekly ACT questionnaire through a patient portal or input environment. The patient portal can typically be a secure web-based portal which provides authenticated access, using Hypertext Transfer Protocol Secure, to patient-specific views. Questions in the weekly ACT questionnaire can be adapted and validated for frequent periodic, e.g. weekly (rather than monthly, as in the standard ACT), assessment of chronic asthma control in children 2-18 years of age. The child (alone or with parental assistance) or the parent of a younger child completes the questionnaire once every period (e.g. typically about 7 days although substantially less than one month). Users can also view prior responses and edit current responses prior to submission. Additional information collected includes weekly compliance with controller medications, information about unscheduled clinic visits, emergency department or hospital admissions, as well as comments that users enter when they want to explain a low score, such as exposure to a known asthma trigger or environmental condition.

The questions used in one example of a weekly ACT questionnaire are shown in Table 1, followed by the answer options associated with each answer:

TABLE 1
During the PAST WEEK:

How much of the time did your asthma keep you from getting as much
done at home, school, or work?

| | | | | |
|---|---|---|---|---|
| 1. All of | 2. Most of | 3. Some of | 4. A little of | 5. None of |
| the time | the time | the time | the time | the time |

How often have you had shortness of breath?

| | | | | |
|---|---|---|---|---|
| 1. More than | 2. Once a | 3. Three to | 4. Once or | 5. Not at all |
| once a day | day | six times | twice | |

How often did your asthma symptoms (wheezing, coughing, shortness of
breath, chest tightness or pain) wake you up at night or earlier than usual
in the morning?

| | | | | |
|---|---|---|---|---|
| 1. Four or | 2. Three | 3. Two | 4. One night | 5. Not at all |
| more nights | nights | nights | | |

How often have you used your quick-relief inhaler or nebulizer medication
(such as albuterol, Ventolin ®, Proventil ®, or Maxair ®)?

| | | | | |
|---|---|---|---|---|
| 1. Three or | 2. One or | 3. Two or | 4. Once this | 5. Not at all |
| more times | two times | three times | week | |
| per day | per day | during the | | |
| | | week | | |

How would you rate your asthma control?

| | | | | |
|---|---|---|---|---|
| 1. Not | 2. Poorly | 3. Somewhat | 4. Well | 5. Completely |
| controlled | controlled | controlled | controlled | controlled |
| at all | | | | |

The weekly ACT questions are each scored from 1 to 5, where higher scores represent better asthma control and lower scores represent a worsening control of the asthma. Thus, a higher score represents a healthier patient, while a lower score represents a patient whose management routine may need to be adjusted. The ACT as presented in this example has been rigorously validated for use in this fashion, in asthma patients, through scientific study reported elsewhere.

The patient can also enter additional information at each periodic report. The tracking software can collect information relating to compliance with the medications and management routine already in place for the chronic medical condition, as well as indications of loss of optimal control of the disease. For example, the questionnaire of Table 1 includes questions for the patient about whether the patient used a controller medication during the week, whether an asthma flare-up caused the patient to take a steroid liquid or pill by mouth, whether the patient used anything besides prescription medications to ease asthma symptoms, whether the patient had any unscheduled sick visits to the doctor, whether the patient had any unscheduled sick visits to a hospital, and any additional comments the patient may have. This additional information can be used by the care coordinator and/or the PCP to monitor the condition of the patient over time and to adjust management of the chronic health condition. A PCP can be a physician, physician assistant, nurse practitioner, licensed independent practitioner, or the like.

After the patient completes a periodic ACT, the results of the ACT can be received by the server. The receiving can be accomplished by electronic transfer of information from a patient computing device to the server. For example, the tracking software running on the server can display the ACT questionnaire to the patient in the form of a website viewable in a web browser on the patient computing device. The website can include forms with fields that are fillable by the patient. The tracking software can be configured to retrieve answers entered by the patient into the forms and save the answers on the server.

In addition to receiving answers to the ACT questionnaire, the server can receive data from an electronic sensing or measuring device. The electronic sensing or measuring device can be used to collect and automatically transmit information about the patient to the tracking software. For example, an asthma tracking application can receive data from a device that counts doses of medication such as inhaler actuations, or a peak flow meter. For other chronic medical conditions, examples of devices can include but are not limited to, a blood pressure monitoring device, a weight scale, a home technology that can be configured to submit information such as a continuous positive airway pressure device used for sleep apnea transmitting current settings and monitored respiratory pauses, or for diabetes, a device that measures blood glucose. Such a device can be connected to the patient computing device or can communicate directly with the server through a wired or wireless connection. Thus, the server can receive both self-reported answers to the ACT questionnaire as well as objective data from the electronic device.

As shown in FIG. 2, the server can also receive information from an external data source 212. The external data source can include a variety of types of data that can be useful for correlating with patient asthma management. For example, poor asthma control is frequently associated with patient exposure to environmental triggers including poor air quality with inhaled particulates, inhaled allergens, viral respiratory infections and even factors such as stress, physical activity and weather. Longitudinal asthma control data generated by the tracking software can be linked with environmental data (including air quality, viral prevalence data, allergy data, temperature, humidity, and data from self-reported home trigger assessments) to personalize asthma care by correlating individual patterns of variation in asthma control status over time to changes in specific environmental triggers. Other types of external data can also be used, including data relevant to other chronic medical conditions such as compliance with chronic medication refill schedules. The data can be associated over time with the patient data and probabilistic predictive models constructed to personalize care of the chronic medical condition and allow a health care provider to make more informed and even preemptive decisions for the treatment of the chronic medical condition based on the patient provided and external information made available. In one particular embodiment, the server can record atmospheric and environmental conditions occurring during each period corresponding to each periodic ACT to correlate such conditions with patient data and to enable the care coordinator to monitor the ACT score of the patient relative to the atmospheric and environmental conditions.

After receiving the ACT results, the server can then identify an ACT score based on the results. In the example of Table 1, the ACT score is simply the sum of the scores of individual questions on the weekly ACT questionnaire. A higher score corresponds to better asthma control. The server can also assign the score to a range, such as a poor control range, intermediate control range, and good control range. These ranges can be set based on the specific scoring method and chronic medical condition. In the example of Table 1, scores of 14 or less are in the poor control range, 15 to 18 are in the intermediate control range, and 19 to 25 are in the good control range. In other embodiments, including embodiments for managing other chronic medical conditions, different scoring systems can be used. For example, scores from individual questions can be combined using various weighting factors or formulas to arrive at an overall score. Objective data from an electronic sensing or measuring device can also be incorporated into the overall score. If there are two or more interacting factors relating to the chronic medical condition, such interactions can be incorporated into the scoring system, for example by multiplying or dividing the individual scores for questions or measurements relating to the interacting factors. Statistical methods can be used to develop scoring systems that provide the health care provider with useful information about the patient chronic medical condition.

Depending on the configuration of the tracking software, the ACT score can be identified by calculating the overall score on the server, or the ACT score can be calculated on the patient computing device and communicated to the server where the server can identify the score as the overall ACT score. For example, the tracking software module can provide the ACT questionnaire to the patient in the form of a website with fillable forms, and the server can retrieve answers to the questions from the forms and then calculate the overall ACT score. In other embodiments, the website can include client-side scripts that automatically calculate the overall ACT score and then the server can retrieve and identify the overall ACT score from the patient computing device.

After identifying the ACT score, the server can send at least one of the ACT results and the ACT score for each ACT to a care coordinator to enable the care coordinator to monitor the asthma management of the patient. As shown in FIG. 2, the care coordinator 204 can be in communication with the server so that the tracking software 202 can send the ACT results and/or ACT scores to the care coordinator. The server and tracking software can be owned and operated by the care coordinator, or the server can be a webhosting server owned by a third party. Also, the tracking software can be a product made available to the care coordinator via a third party that owns the tracking software. The tracking software can operate on a secure server that is accessible to both the care coordinator and the patient. The server can be located at the care coordinator, or can be accessible to the care coordinator and the patient via a secure wired or wireless connection.

The care coordinator 204 can be capable of monitoring the chronic health condition of the patient 208. A care coordinator can be any entity that coordinates between patients and PCPs 206. For example, the care coordinator can be a clinic, clinic manager, doctor's office, health care coordinator, or nurse manager associated with a local hospital or health care concern. In some cases, the PCP may also function as a care coordination role, directly interacting with the tracking software without an intermediary care coordinator.

The care coordinator 204 can enroll 216 the patient 208 in the tracking system. The server can receive an instruction from the care coordinator to enroll the patient so that the patient can submit periodic asthma control test results. The care coordinator can have an account in the tracker software 202 that allows the care coordinator to manage accounts for patients and PCPs 206. For example, the care coordinator can create new patient logins, view patient scores and graphs, read or make notes on a patient's progress, contact patients by email, edit patient information, and remove a patient from the system.

The care coordinator 204 can also be responsible for communicating 214 with the patient 208. The care coordinator and/or tracking software 202 can offer automated reminders to the patient to complete weekly ACTs, and provide feedback such as encouragement, based on the ACT results, or comments on how the patient can improve asthma management. If a patient does not comply with the ACT schedule, such as completing two or fewer ACTs in a 20-day period, the patient can be classified as a low compliance patient. These patients can be added to a “Low Compliance Patient” group and displayed within a specific portion of the program. If the patient has not completed the ACT for an excessive period (e.g. 1-3 days overdue), then the program can send an email and/or text message to the patient reminding the patient to complete the ACT. The care coordinator can also send an additional reminder using a secondary contact method such as email, phone or letter. If a patient does not keep track of the patient's asthma control, it can be difficult for the care coordinator and PCP to know if the patient needs any changes made to the plan of care for the patient. The patient can select an option to receive a text message or email reminder alert if the patient does not complete the ACT within the desired time period, such as each week. An alert can also be received if a patient has a low score. If a patient is a minor, temporarily or permanently impaired, or otherwise at risk individual, an email reminder and/or alert can be sent to a parent, guardian, caregiver, or responsible related individual.

The care coordinator can also contact the PCP of the patient based on the information provided by the patient. For example, if the ACT scores are below a validated threshold, the care coordinator can encourage the patient to set up a visit with the PCP. The PCP can also be alerted to the need for a visit or other encounter to adjust therapy to assist the patient with management of the chronic health condition.

The care coordinator can also monitor the patient data and/or score over a period of time. If the score over time indicates a worsening of the chronic health condition, the care coordinator and/or tracking software can send an indication to the patient and/or PCP indicating the need to set up a visit. The PCP can view the data that is periodically provided by the patient to the tracking software to trend chronic disease management and use the information to help the patient better manage the chronic health condition.

The server can communicate the ACT results and/or ACT score for display at a computing device of the care coordinator. The tracking software can display ACT scores and results to the care coordinator in a variety of ways. For example, the software can display the ACT scores over a specified period of time, or the software can display individual answers to ACT questions. For example, several views can be available to the care coordinator. In one view, a patient name, contact information, and ACT scores over a selected period of time are viewable to the care coordinator. Patient scores can be viewed by clicking on a “Patients” tab. From this tab, the care coordinator can view detailed information about patient scores, add notes, view graphs of the patient scores, and edit or remove patient information.

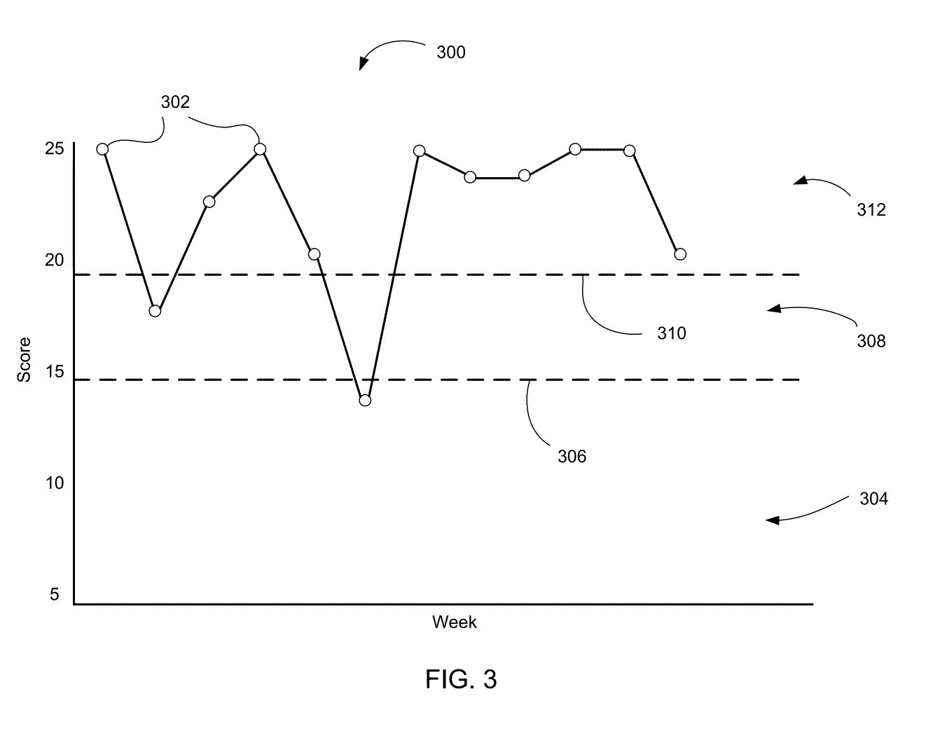

An example of a graph of patient ACT scores is shown in FIG. 3. The graph 300 displays a plot of score vs. week over a period of twelve weeks, with a weekly reporting rate. Data points 302 represent the ACT score for a particular week. The data points are linked by lines, allowing the care coordinator to easily see trends in the patient ACT score. The graph also shows a poor control range 304 beneath a poor control threshold 306, an intermediate control range 308 between the poor control threshold and an intermediate control threshold 310, and a good control range 312 above the intermediate control threshold. These regions can be optionally color coded by shading the regions, for example, red, yellow, and green for poor, intermediate, and good, respectively. This allows the care coordinator to easily identify ACT scores that can be a cause for concern. Also, the care coordinator can customize the graph by choosing a time period to display, such as 1 month, 3 months, 6 months, or 12 months. The graph can be interactive so that clicking on a data point will open the detailed ACT results for that particular ACT. Any ACTs with comments from the patient, care coordinator, or PCP can be identified by an icon on the graph near the data point.

The care coordinator can also create accounts for PCPs to use the tracking software. In this manner multiple PCPs can be associated with specific patients or groups of patients. The PCPs can be assigned a desired number of patients. The care coordinator can view all patients in the system, while the PCPs can view their own patients. Both the care coordinator and PCPs can view lists of patients, flagged patients, low score patients, and low compliance patients. In some embodiments, only the care coordinator can add new accounts for patients and PCPs and assign patients to PCPs.

The care coordinator and the PCPs can add notes. For example, a note can be entered to discuss the asthma medication of the patient at the next visit. A check box can be selected to set a flag for any unresolved issues to alert the care coordinator or PCP at their next log in. Previous notes, and unresolved issues, can also be viewed. When the “unresolved issue” box is checked, the patient is added to a list of flagged patients. The flagged patient list can be viewed by selecting a “flagged patient” tab or function in the program. Once the unresolved issue box is unselected, the patient will no longer be listed on that page.

Low score patients can be identified by scores which exhibit consistent poor and/or intermediate scores over multiple data points. For example, a low score can be defined as a score that is in the red zone for at least a week or in the yellow zone for at least two consecutive weeks. This allows the care coordinator or PCP to determine which patients will need assistance with their asthma management and prioritize follow-up care.

The care coordinator can coordinate asthma care for several providers in a common clinic, while the provider views or manages their own patients. The care coordinator can also optionally manage all patients in a clinic including tasks such as inviting patients to use the score system, assign a provider, and enrolling providers into the management system. The care coordinator role can be assignable. For example, in some situations a PCP may be both a provider and a care coordinator, e.g. in a solo-practitioner office or at the PCP's discretion.

The care coordinator can monitor the asthma status of patients for the entire clinic in a systematic fashion, typically at least daily and in some cases more often. The system allows the care coordinator to quickly and easily identify which patients are doing well, which are developing problems with their asthma control, which are not compliant with entering data, and which have been flagged for follow up actions. For example, a care coordinator might review asthma tracking reports in the morning and discover that a patient has entered the ‘red zone’. The care coordinator may then contact that patient by phone or email, or other communication, to schedule an appointment. The system also allows the care coordinator to create a reminder note that the patient should have an appointment scheduled during the following week, and create a flag of the patient record to follow up on the request to schedule an appointment over the next few days (e.g. within 4 days). In this example, the following day, while reviewing the tracking reports, the care coordinator can see that flagged patient, and double-check with scheduling that an appointment was made, etc. Part of the coordinator's daily routine can also be to forward to individual providers an alert outlining individual patients which are having difficulty with their asthma management, and suggesting that they sign on to the tracking system to view such flagged patients. An individual PCP, in contrast, may only look at their patient's data when the patient is in the office for a visit, unless alerted to a problem by the care coordinator. This arrangement allows comprehensive asthma monitoring and management at the clinic level, while leaving the individual providers free to complete their usual days work without interruption except for cases in which intervention is indicated.

The tracking software can also allow the patient to view previous ACT scores and results. For example, the patient can view the graph of ACT score as a function of multiple weeks such as the graph shown in FIG. 3. Generally, a patient can view the same data and graphs visible to the care coordinator and PCPs, but for that single patient only. In one example, the program automatically calculates and plots the total weekly ACT scores on the color-coded graph. A pop-up message box containing recommendations is displayed to the patient. The graphic display shows whether the asthma of the patient is 1) well-controlled (Green), 2) not well- (Yellow), or 3) poorly-controlled (Red). Each color can be associated with a pop-up message box containing specific recommendations including whether the patient should 1) continue regular follow-up care (Green zone), 2) schedule an early follow-up visit with the PCP (2 consecutive weeks or more in Yellow zone) or 3) schedule an immediate follow up appointment with the PCP (Red zone). Decision support can be provided by short phone text messages or longer email messages tailored to the patient's specific patterns of asthma control sent to both the patient and parent. This can facilitate behavioral changes based on application of the Health Belief Model framework by increasing patient awareness of chronic asthma symptoms, improving self-efficacy and providing cues to action (skills to respond to deterioration of asthma control and to take responsibility for managing acute exacerbations).

When a patient schedules a visit to see a PCP, the patient can provide a copy of the ACT score graph for the PCP to review the ACT scores of the patient since the last visit by means of a print function included as part of the software. If the patient recorded comments within the tracking software for one or more of the ACT scores, then these comments can be included with the provided graph. This provides a helpful tool to the PCP to determine if any changes should be made to the patient's action plan, overall plan of care, trigger and avoidance plan, or chronic medical management of the patient.

The tracking software can also display a progress monitoring bar to provide feedback to the patient to encourage regular use of the software. The bar can advance after each week of completing the ACT until the bar reaches “100 points!” at 4 weeks, at which time there is feedback in the form of an animation in the software, or the potential for a premium, gift, or other tangible reward for compliance with use. For example, an insurance company can discount insurance premiums to patients who are regularly compliant with using the software and thereby avoid acquiring excess medical costs. In one example, the system can produce a compliance form for use in insurance reporting which outlines a degree of program compliance by the patient.

In some embodiments the server can also send the ACT result and/or ACT score to the PCP of the patient. The PCP can be a licensed medical practitioner that provides medical care to the patient. The PCP can in some cases be a physician, physician assistant, or nurse practitioner. The PCP of a patient can be the practitioner that diagnosed the patient with the chronic medical condition of the patient and/or the practitioner providing continued medical care to the patient. As shown in FIG. 2, the PCP 206 can identify high risk patients 218 so that the care coordinator 204 can enroll 216 the patients 208.

The PCP can have an account for logging into the tracker software, so that the PCP can view the ACT results and scores of patients. The PCP can also choose to receive real-time feedback through auto-email and auto-fax messages to alert the PCP when a patient has a low ACT score.

The PCP can be independent or employed by the care coordinator. For example, a care coordinator can be a clinic with several PCPs practicing at the clinic. The clinic can be responsible for handling creation of accounts in the tracking software for the PCPs and patients. The clinic can also monitor the data submitted by patients through the tracking software and make recommendations for patients to schedule visits with the PCPs when necessary.

The tracking software can also include a “Maintenance of Certification” module that allows PCPs to use the tracking software to perform quality improvement projects around asthma in their medical practice which can be used to fulfill requirements of recertification by the American Board of Pediatrics or other board organizations such as the American Board of Family Medicine or the American Board of Internal Medicine. This module can involve collection of additional significant information about a specific patient's asthma control that will assist the physician in making medical decisions about the patient's asthma care in accord with the National Heart, Lung, and Blood Institute evidence-based recommendations for asthma care.

The tracking software can be configured to send electronic alerts from the server to the patient, care coordinator, and/or PCP. These alerts can be used to instruct the patient, care coordinator, and/or PCP to schedule an early visit to discuss the chronic medical condition management of the patient. As shown in FIG. 2, alerts 220 can be sent from the tracking software 202 on the server to the patient 208 and the care coordinator 204. The alert can be passed on from the care coordinator to the PCP 206. In some embodiments, the alert can be sent directly from the server to the PCP as well.

For example, alerts can be sent when the patient has a low ACT score and an early visit with the PCP is needed. Specifically, if the ACT score is in the poor control range (14 or below) then the server can send an alert to the patient and/or the care coordinator instructing the patient and/or care coordinator to set up a visit between the patient and the PCP within a week of the electronic alert so that the PCP can adjust the asthma management of the patient. In one example, the alert instructing the patient and/or care coordinator to set up an appointment with the PCP within one week is sent any time the patient scores in the red zone, even when the patient scores in the red zone for only a single week. Also, if the patient scores in the intermediate control range (15 to 18, or the yellow zone) for two or more consecutive weeks, then the server can send an alert instructing the patient and/or care coordinator to set up a visit between the patient and the PCP to discuss the asthma management of the patient. Because the yellow zone is not as serious as the red zone, the visit with the PCP is not necessarily set up within one week of the alert. However, the visit can be set up earlier than the normal return visit date of the patient. Alerts sent to the patient can instruct the patient to continue to follow all parts of the Asthma Action Plan of the patient until the next visit with the PCP. When the patient scores in the good control range (19 to 25, or the green zone), the server can send a notification to the patient informing the patient that the asthma control of the patient is good, and the patient can visit the PCP at a regularly scheduled routine visit.

The alerts for scoring in the yellow zone or red zone can also be sent to the PCP. In some cases, the server can send the alerts directly to the PCP. In other cases, the care coordinator can pass the alerts along to the PCP. In situations where the care coordinator is responsible for scheduling appointments between patients and PCPs, the care coordinator can schedule early visits for patients with low ACT scores without sending the alerts to the PCP. In other situations, where the PCP or an assistant of the PCP schedules patient appointments, and not the care coordinator, the care coordinator can pass along alerts to the PCP or assistant of the PCP so that an appointment with the patient can be scheduled.

Several examples are provided in the proceeding paragraphs with respect to the tracking and monitoring of asthma. However, this is not intended to be limiting. The management of a wide variety of chronic medical conditions can be similarly improved using the processes disclosed herein. For instance, medical and health conditions such as well-child visits, pregnancy, drug monitoring, diabetes, chronic obstructive pulmonary disease (COPD), congestive heart failure, addiction management, pain management, cystic fibrosism, and other conditions listed previously can be managed through recording, tracking and monitoring of health information by patients and health care providers. This list of chronic medical and health conditions is not intended to be limiting. Additional chronic medical conditions including all conditions sensitive to regular longitudinal monitoring and management can also be included, as can be appreciated. Multiple problems in one patient and/or a complexity of problems where diagnoses or therapies have a compound effect on treatment and management of the illnesses can also be addressed via suitable management protocols.

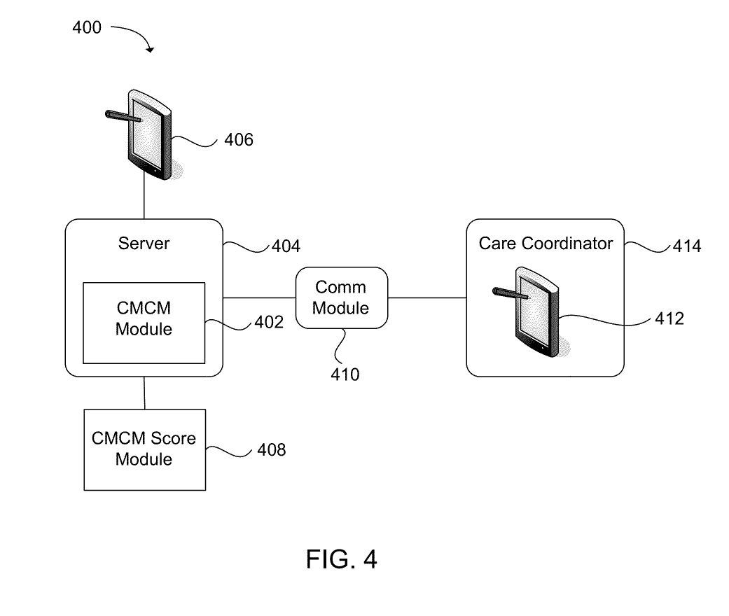

FIG. 4 illustrates one example of a chronic medical condition management system 400, in accordance with one embodiment of the present invention. The system comprises a chronic medical condition management (CMCM) module 402 residing on a server 404. The chronic medical condition management module is configured to receive, periodically, a chronic medical condition management test (CMCMT) result from a patient computing device 406.

The system 400 further comprises a CMCM score module 408 in communication with the server 404. The CMCM score module is configured to identify a CMCM score from the CMCMT. This score module can be integrated onto the server 404 or may be remotely located and in electronic communication with the server.

The system 400 also comprises a communication module 410 in communication with the CMCM module 402. The communication module is configured to electronically communicate at least one of the CMCMT results and the CMCM score to a computing device 412 located at care coordinator 414 to enable the care coordinator to monitor a chronic medical condition of a patient over a selected time period based on data received at the periodic rate. The communication module can be any type of communication system used to communicate the data via a wired or wireless connection from the server to the computing device at the clinic, as can be appreciated. For example, a private internet connection can be used, along with a protocol such as secure hypertext transfer protocol (https) to communicate data between the CMCM module in the server and the computing device at the clinic.

All of the features described above with respect to methods of improving asthma management can also be applied to a chronic medical condition management system for any chronic medical condition. Features of the software such as account management, graphs of test scores, alerts, multiple choice question forms, external data sources, electronic sensing and measuring devices, and all other such features can be adapted to other chronic medical conditions.

A further embodiment of the described methodology can be used in clinical medical research to reduce unmeasured variation in research subjects by establishing a uniform baseline approach to disease management that is monitored and verified, along with measurement of longitudinal disease control and an opportunity to provide feedback to subjects and/or to alter management in one or more arms of the research study.

Various techniques, or certain aspects or portions thereof, may take the form of program code (i.e., instructions) embodied in tangible media, such as floppy diskettes, CD-ROMs, hard drives, non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, EPROM, flash drive, optical drive, magnetic hard drive, or other medium for storing electronic data. The base station and mobile device may also include a transceiver module, a counter module, a processing module, and/or a clock module or timer module. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

It should be understood that many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, modules, steps, or characteristics may be combined in any suitable manner in one or more embodiments. While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method for improving asthma management of a patient, comprising:
receiving, at a server, periodic asthma control test (ACT) results from the patient, wherein the server is in communication with a care coordinator;
identifying, at the server, an ACT score for the patient in each asthma control test; and
sending, from the server, at least one of the ACT results and the ACT score for each ACT to the care coordinator to enable the care coordinator to monitor the asthma management of the patient.

2. The method of claim 1, further comprising sending, from the server, at least one of the ACT results and the ACT score for at least one ACT to a primary care provider (PCP) of the patient.

3. The method of claim 2, wherein the PCP is selected from a doctor, a physician assistant, and a nurse practitioner.

4. The method of claim 2, further comprising sending an electronic alert from the server to at least one of the patient and the care coordinator when the ACT score is in a poor control range, wherein the alert instructs at least one of the patient and the care coordinator to set up a visit between the patient and the PCP within a week of the electronic alert to adjust the asthma management of the patient.

5. The method of claim 4, further comprising sending an alert from the care coordinator to the PCP wherein the alert instructs the PCP to set up a visit between the patient and the PCP within a week of the alert to adjust the asthma management of the patient.

6. The method of claim 2, further comprising sending an electronic alert from the server to at least one of the patient and the care coordinator when a selected number of consecutive ACT scores are in an intermediate control range, wherein the alert instructs at least one of the patient and the care coordinator to set up a visit between the patient and the PCP to discuss the asthma management of the patient, and wherein the selected number of consecutive ACT scores is at least two.

7. The method of claim 6, further comprising sending an alert from the care coordinator to the PCP wherein the alert instructs the PCP to set up a visit between the patient and the PCP to discuss the asthma management of the patient.

8. The method of claim 2, further comprising sending a notification from the server to the patient when the ACT score is in a good control range, wherein the notification informs the patient that the asthma control of the patient is good, and the patient can visit the PCP at a regularly scheduled routine visit.

9. The method of claim 1, further comprising recording, at the server, atmospheric and environmental conditions occurring during each period corresponding to each periodic ACT to enable the care coordinator to monitor the ACT score of the patient relative to the atmospheric and environmental conditions.

10. The method of claim 1, wherein sending at least one of the ACT results and the ACT score further comprises communicating at least one of the ACT results and the ACT score for display at a computing device of the care coordinator.

11. The method of claim 1, wherein the care coordinator is a clinic, a clinic manager, a doctor's office, or a nurse manager.

12. The method of claim 1, further comprising receiving, at the server, information from an electronic measurement device.

13. The method of claim 1, further comprising receiving, at the server, from the care coordinator, an instruction to enroll the patient so that the patient can submit periodic asthma control test results.

14. The method of claim 1, wherein the periodic ACT is a weekly ACT.

15. At least one non-transitory machine readable storage medium comprising a plurality of instructions adapted to be executed to implement the method of claim 1.

16. A chronic medical condition management system, comprising:
a chronic medical condition management (CMCM) module residing on a server, wherein the chronic medical condition management module is configured to receive, at a periodic rate, chronic medical condition management test (CMCMT) results from a patient computing device;
a CMCMT score module in communication with the server, wherein the CMCMT score module is configured to identify a CMCMT score from the CMCMT; and
a communication module in communication with the CMCM module, wherein the communication module is configured to electronically communicate at least one of the CMCMT results and the CMCMT score to a care coordinator computing device to enable a care coordinator to monitor a chronic medical condition of a patient over a selected time period based on data received at the periodic rate.
